(19) United States
(12) Patent Application Publication
(10) Pub. No.: US 2011/0039974 A1
(43) Pub. Date: Feb. 17, 2011

(54) COMPOSITE MATERIAL

(76) Inventor: Franz Vekoerrer, Huenenberg (CH)

Correspondence Address: FLYNN THIEL BOUTELL & TANIS, P.C., 2026 RAMBLING ROAD, KALAMAZOO, MI, 49008-1631, US

(21) Appl. No.: 12/450,293

(22) PCT Filed: Mar. 20, 2008
(86) PCT No.: PCT/EP2008/002302

§ 371 Date: Mar. 8, 2010

(30) Foreign Application Priority Data
Mar. 20, 2007 (DE) 10 2007 013 415.2

(51) Int. Cl. A61C 13/00

(52) U.S. Cl. 523/115

(57) ABSTRACT

A composite material for producing dental prostheses with a matrix comprising a thermoplastic (A) contains reinforcing fibers (B) and at least one filler (C). The filler (C) has a Mohs hardness that is at most as great as the Mohs hardness of the reinforcing fibers (B).

This invention relates to a composite material for producing dental prostheses. Further to semi-finished products made of the composite material in order to produce dental prostheses therefrom, as well as to the dental prostheses produced therefrom themselves.

It is known in the dental area to reinforce thermoplastics with fibers and color them with pigments. In spite of the reinforcing fibers, however, the strength properties of such composite materials often leave something to be desired. In the dental area, primarily bending strength as well as tensile strength are the essential criterion for strong structural components for use as dental prostheses. Further, bending strength and tensile strength are crucial for how thin or how thick the dental prosthesis can be executed. Because only limited space is present in the patient's oral area and furthermore dental prostheses are in most cases provided with esthetic veneers made of other plastics, it is only possible to execute dental prosthetic parts, in particular the substructure parts for dental crowns, dental bridges, etc., very small and thin.

In dental crowns the wall thickness of the crown is also dependent on strength properties. The stronger the material, the thinner the wall thickness of the crown can be. A thinner wall thickness of a crown substructure leaves more space for an esthetic veneer of the substructure. Particularly the form of dental bridges is very strongly determined by the bending strength values of the bridge material. The connector cross sections of the dental bridge must be made thicker in the case of poor material constants to be able to withstand the masticatory loads in the mouth. Here, too, esthetics are very important. Bridges with smaller connector cross sections and lower anchor wall thicknesses can be veneered more esthetically. Esthetics are vital here, too. Metal-free dental bridges made of thermoplastic composite materials have not been employable in many cases because the bending strength properties and tensile strength properties were insufficient.

The object of the invention is to substantially improve the strength properties of thermoplastic composite materials by admixing inventive fillers and thereby to provide a solution for metal-free and esthetic dental prostheses.

Fiber composites with a thermoplastic matrix are usually produced by fusing the thermoplastic in order to mix reinforcing fibers and/or fillers into the composite. The aim is a homogeneous distribution of reinforcing fibers and/or fillers as well as the avoidance of agglomerations in order to obtain nearly isotropic material properties. For this purpose it is customary to employ screw extruders, primarily double screw extruders, and the temperature of the melt is generated not only through the heating of the screw extruder but in particular also through the kneading and shearing processes arising in the extruder upon incorporation of the particular components. Said kneading and shearing processes cause not only the plastic to be heated by frictional energy, however, but also the reinforcing fibers to be incorporated to be pressed against other reinforcing fibers, and above all reinforcing fibers against fillers likewise to be incorporated, in particular pigments. Evidently, this mixing in of reinforcing fibers and further fillers causes corresponding damage to the surface of the reinforcing fibers, so that certain strength values cannot be exceeded even in the static bending test. Further, there is a strong drop in the values for alternating load resistance.

In the production of long fiber thermoplastics, continuous fiber strands are wetted and/or fused with a thermoplastic and guided through a profile, so that the length of the resulting fiber composite profile corresponds to the length of the reinforcing fibers present in the profile. Such profiles can be employed as granules with e.g. a 3 millimeter diameter for further processing into dental prostheses. In particular, such profiles with a greater diameter can also be employed for machining into dental prostheses as a semi-finished product.

Surprisingly, the strength properties of fiber composites are improved when, as stated in claim 1, there is added according to the invention a filler having a Mohs hardness that is at most as great as the Mohs hardness of the reinforcing fiber.

Preferably, the filler has a Mohs hardness that is smaller by at least one, preferably two, hardness levels according to the Mohs hardness scale than the hardness of the reinforcing material.

As it has turned out, the reinforcing fiber need only have a higher Mohs hardness on the outside. That is, it is also possible to use reinforcing fibers having a coating with a Mohs hardness of at least the Mohs hardness of the filler, but possessing a core of lower Mohs hardness. In the same manner, the filler, for example a pigment, can possess a lower Mohs hardness than the reinforcing fiber only on the outside, so that pigments can also be used that possess a core of higher Mohs hardness but are provided with a coating with a Mohs hardness that is lower than the Mohs hardness of the reinforcing fiber or the coating thereof.

The invention primarily offers advantages for short glass fiber reinforced composite materials. However, it quite generally also provides the inventive advantage when, in the presence of reinforcing fibers, the latter are protected against other reinforcing fibers and/or fillers with the fillers according to claim 1 as a spacer.

It has further turned out that it provides an advantage according to the invention when the average diameter of the filler is less than 50%, preferably less than 15%, particularly preferably less than 8%, of the average diameter of the reinforcing fiber. An optimal strength is obtained for example when there are employed in a polyaryletherketone (PAEK), in particular a polyetheretherketone (PEEK), glass fibers with a Mohs hardness of approx. 6 with an average diameter of 8 microns to 12 microns as well as pigments, such as in particular zinc sulfide, with a Mohs hardness of 3, with an average diameter of approx. 0.3 microns. In this optimal variant the average diameter of the filler pigment is between 3.57 percent and 2.5 percent of the average diameter of the stated reinforcing fiber.

A special advantage of the invention is a high enrichment of the thermoplastic matrix with the inventive filler which has a lower Mohs hardness than the reinforcing fiber itself. Hitherto it was thought that fillers act as a “matrix spoiler” in components with high mechanical strengths, so that there was always an attempt to mix as little filler as possible into the composite material. According to the invention it has been found that an increase in fillers provides substantial advantages with respect to bending strength. Another advantage results when the filler is incorporated into the thermoplastic matrix and homogeneously distributed before incorporation of the reinforcing fibers. When the reinforcing fibers are subsequently mixed in, the already incorporated fillers act as a spacer or stress absorber between the reinforcing fibers, thereby avoiding otherwise usual contact between the fibers. The more fillers are incorporated, the better the alternating load resistance of the composite material is. The limit for the filler is the detectable drop in mechanical properties, which arises due to a disproportion to the matrix. Thus it has been found that bending strength, in particular alternating bending load strength, can be increased when the weight ratio of the filler according to claim 1 to the thermoplastic is less than 1:15, preferably 1:11, particularly preferably less than 1:6.

Very good strength values have been achieved when the composite material employed as a dental prosthesis [has (The Translator)] as a thermoplastic matrix 50 wt. % of a polyetheretherketone (PEEK) into which first 15 wt. % of zinc sulfide is incorporated and thereafter 35 wt. % of S-glass fibers with a high temperature resistant sizing. The described inventive ratio is in this case 15 wt. % of filler to 50 wt. % of thermoplastic as a matrix, i.e. a ratio of 1 to 3.33. Upon use of this formulation the composite material reaches a bending strength of 330 MPa, whereby the alternating bending load strength was also substantially increased in relation to known composite materials. It can be concluded that not only the gentle incorporation of the reinforcing fibers through the fillers used as a spacer between the fibers provides a considerable advantage, but that the presence of well distributed and numerously present fillers, which also attach to the reinforcing fibers in the compound, also permits increases in alternating load resistance according to the invention in a surprising manner. These spacing fillers evidently absorb the stress upon mechanical load from the reinforcing fibers.

It is possible according to the invention to admix further fillers (pigments, fibers, etc.) to the composite material.

When the Mohs hardness of the further filler is equal to or greater than the Mohs hardness of the reinforcing fiber, the further filler must be smaller in size than the filler according to claim 1 and, further, the weight ratio of the further filler to the filler according to claim 1 must be more than 1 to 3, preferably more than 1:4 and particularly preferably more than 1:5. This permits damaging contact by the further “hard” filler to be almost entirely avoided. Often it is necessary to color plastics such as polyaryletherketones that possess a dark inherent color. The inventive use of a spacing filler offers the possibility of employing smaller white or color pigments in addition for brightening, without extremely worsening the mechanical properties. Without the inventive filler according to claim 1 as a spacer, an extremely poor bending strength would otherwise be present, because the fibers are damaged too greatly.

The inventive composite material is suitable in particular for thermoplastic high temperature plastics with a melting or processing temperature of at least 300° C., in particular more than 330° C. In amorphous thermoplastics the processing temperature is above the glass transition temperature (Tg) and in semicrystalline thermoplastics above the melting temperature.

The thermoplastics used are in particular semicrystalline thermoplastics with aryl groups in the main chain. Suitable aromatic thermoplastics with aryl groups in the main chain are in particular high temperature thermoplastics, such as polyarylates, polyarylene sulfides, polysulfones, liquid crystal polymers, in particular liquid crystal polyesters, polyimides, polyetherimides, polyamidimides or polyaryletherketones, as well as copolymers comprising at least two of the above-mentioned polymers or a blend comprising at least two of the above-mentioned aromatic thermoplastics.

It is particularly preferable here to use polyaryletherketones (PAEK) such as polyetherketone (PEK), polyetheretherketone (PEEK), polyetherketoneketone (PEKK), polyetheretherketoneketone (PEEKK) or polyetherketoneetherketoneketone (PEKEKK) or similar linkages of ether and ketone units, further copolymers comprising at least two of said polyaryletherketones or a blend comprising at least two of said polyaryletherketones.

The above-mentioned plastics are viscous in relation to most engineering plastics due to the molecular structure and the aryl groups in the main chain and can only be processed through high temperatures.

Such plastics are very tough in processing and the reinforcing fibers are thereby loaded more strongly upon mixing in while interacting with the fillers than in easy-flowing plastics.

It is evident that the reinforcing fibers and the fillers are provided with temperature-resistant sizings. Further, it is self-evident that the pigments are selected to be biocompatible.

The filler can preferably be a pigment filler, but e.g. also a radiographic contrast agent. The pigment filler is preferably a white pigment and/or a color pigment. The optical refractive index of the pigment filler, i.e. of the white pigment or color pigment, is preferably more than 2, so that plastics having a rather dark inherent color can be better brightened and/or colored. In dental prosthetic parts a light color between white and ivory-colored is desired.

Polyaryletherketones mostly have a dark inherent color or continually deviate in basic color due to the production process, so that such plastics must be brightened and/or colored for use as dental prostheses. With conventional composite materials based on polyaryletherketones, bending strength values of only under 200MPa have been reached. Further, conventional polyaryletherketone composite materials were very brittle and did not achieve the desired success in alternating load resistance.

The average particle diameter of the pigment filler is preferably smaller than the diameter of the reinforcing fibers.

If glass fibers are employed as reinforcing fibers, it is preferable to use zinc sulfide, zinc oxide and barium sulfate as white pigments, namely, as particles with an average particle size of from 0.1 to 0.4 μm. As has been found, such pigment particles attach between the reinforcing fibers, thereby preventing the reinforcing fibers from being able to contact each other.

It has been found that zinc sulfide works very well as a filler and that it evidently has an additional tribological effect on the fibers with additional advantage.

Glass fibers are preferably used in an amount of over 20 wt. %, in particular at least 30 wt. % and particularly preferably at least 40 wt. %, based on the weight of the composite material.

If ceramic reinforcing fibers are employed, for example reinforcing fibers made of zirconium oxide (ZrO₂) or aluminum oxide (Al₂O₃), it is possible to employ for example titanium oxide (TiO₂) as a white pigment. Zirconium oxide preferably has a Mohs hardness of more than 7.5 and the titanium dioxide pigment preferably has a Mohs hardness of less than 7, whereby the rutile type is to be preferred to the anatase type as a titanium dioxide if possible due to the better colorability.

Preferably, a reinforcing fiber made of zirconium oxide is incorporated in PEEK, and as a filler a titanium dioxide pigment is employed. Titanium dioxide has the best refractive index for brightening, and zirconium oxide provides a color similar to ivory. Additionally, zirconium oxide is radio-opaque, which is a further advantage.

The composite material can be formed by a semi-finished product, for example granules, a prepreg, a laminate, a foil, plates or profiles.

The semi-finished product can have any form, being configured to be for example cylindrical, prism-shaped, annular or hollow cylindrical. The semi-finished product can be formed for example by injection molding, extrusion, transfer molding or compression molding. Preferably, the semi-finished product is produced immediately after the mixing-in process of the reinforcing fibers and pigments in heat. That is, there is no intermediate product such as short fiber granules that must be fused again for transformation to a semi-finished product, thereby avoiding another fusing with kneading and shearing processes and fiber damage or fiber load.

The semi-finished product can be a long fiber semi-finished product, i.e. a semi-finished product in which unidirectional fibers extend over the whole length of the granules, extrudate or pultrudate or other semi-finished product, which provides the advantage of higher strengths in the semi-finished product and thereafter in the finished dental prosthetic part.

A special advantage of the invention is that upon the presence of only 35% of glass fibers as described above through the admixture of 15% of zinc sulfide a bending strength of more than 300 MPa can be reached, although only short glass fibers are present. A homogeneous interaction and mutual support can be inferred. It is preferable to employ a composite material, in particular a semi-finished product or a dental prosthesis, that has short glass fibers with an average fiber length between 30 μm and 500 μm, preferably between 100 μm and 300 μm. In particular upon the presence of the above-mentioned mechanical values.

The inventive composite material is suitable in particular for producing dental prostheses. Thus, it is possible for example to produce dental prosthetic parts and dental implants of high strength from the semi-finished product by injection molding. The thus produced dental prosthetic parts even withstand the high torsional forces occurring in the different directions upon mastication, said forces being due to the suspensory apparatus of the natural tooth. The high torsional strength is of benefit to any dental prosthesis, thus not only to fixed dental prostheses, such as crowns, bridges, implant superstructures, etc., but also to removable dental prostheses.

From the inventive composite material it is possible to produce in particular dental prosthetic parts that are currently formed from metal by model casting, for example palatal plates or palatal bars, in particular clasps for fastening to remaining teeth. Quite generally, the inventive composite material is suitable in particular for producing removable dental prostheses for upper and lower jaws. It is also possible to produce therefrom reinforcing elements, in particular for complete dentures, such as base plates.

In particular, the inventive composite material permits dental crowns, dental bridges, dental implants, implant abutments and suprastructures and other implant superstructure components as well as parts for attachment technology to be produced with gracile forms and high strengths. In connection with the invention the term “dental prosthesis” is to be understood comprehensively. It refers here to any part in a patient's oral area that can find use as a replacement for natural or artificial teeth and roots, as a functional part, etc.

In addition, the inventive composite material is suited for producing dental prostheses for lasting, permanent fixed dental prostheses, such as crowns, bridges, implant superstructures. Such dental prostheses produced from the inventive composite material are characterized by their high static strength, bending strength and tensile strength, in particular high fatigue strength under bending stress.

The inventive composite material is processable into a dental prosthesis as a semi-finished product both by machining and thermally. In thermal processing, inventive semi-finished products are heated for example in a refractory material and transformed into dental prosthetic parts thermally in a conventional dental furnace similar to known pressable ceramic systems. Further, the inventive semi-finished product can also consist of a foil which is shaped by thermal deep drawing into the dental prosthetic part such as a dental crown. Such foils have a thickness of less than 4 millimeters, preferably less than 3 millimeters. In foils the homogeneous distribution of the reinforcing fibers and the fillers is especially important.

In machining, the dental prosthetic part is milled by milling machines out of semi-finished products such as the milling blocks usual in the dental area in the form of cubes, cylindrical disks, etc.

Hereinafter the invention will be explained more closely by way of example with reference to the attached drawings.

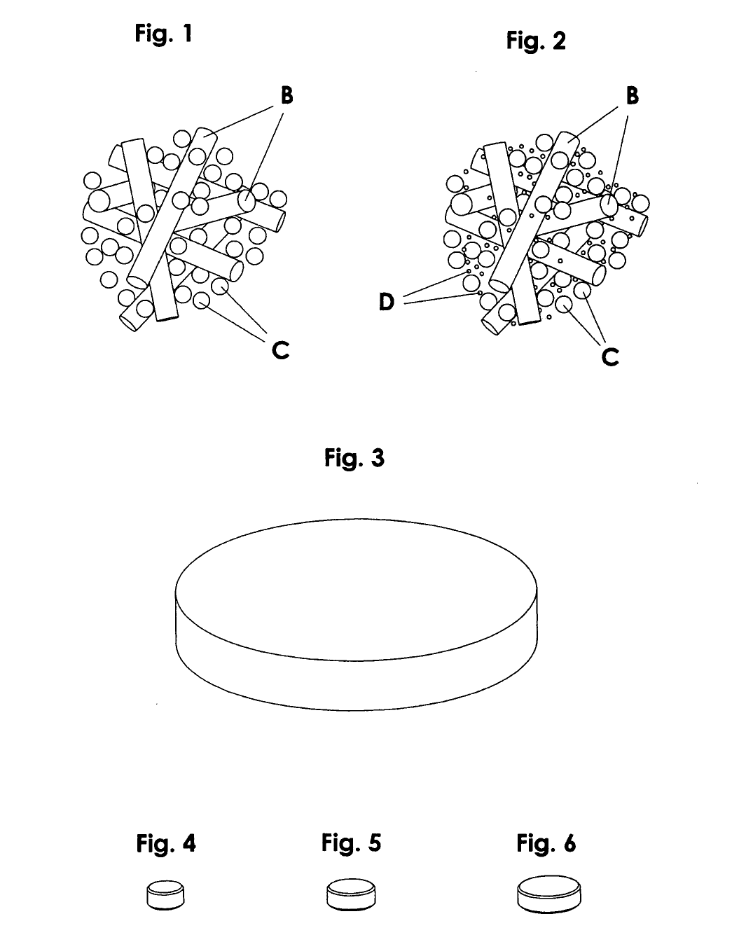

In FIG. 1 and FIG. 2 there are schematically shown in enlarged representation the arrangements of the reinforcing fibers (B), the filler particles (C) and the further filler particles (D).

FIG. 3 shows in perspective a semi-finished product blank for processing into a dental prosthesis by cutting or milling in approximately the actual size.

In FIGS. 4, 5 and 6 there are shown semi-finished product blanks which are intended for thermal processing into dental prostheses, for example in a dental pressing furnace.

1. A composite material for producing dental prostheses, consisting of
A) a matrix comprising a thermoplastic (A),
B) reinforcing fibers (B),
C) at least one filler (C),
characterized in that the filler (C) has a Mohs hardness that is at most as great as the Mohs hardness of the reinforcing fibers (B).

2. The composite material according to claim 1, characterized in that the filler (C) has a Mohs hardness that is smaller than the Mohs hardness of the reinforcing fibers (B) by at least one, preferably two, hardness levels according to the Mohs hardness scale.

3. The composite material according to claim 1, characterized in that the filler (C) has in cross section an average diameter that is smaller than the average diameter of the reinforcing fiber (B).

4. The composite material according to claim 3, characterized in that the average diameter of the filler (C) is less than 50 percent, preferably less than 15%, particularly preferably less than 8%, of the average diameter of the reinforcing fiber (B).

5. The composite material according to claim 1, characterized in that the weight ratio of the filler (C) to the thermoplastic (A) is less than 1 to 15, preferably less than 1 to 11, particularly preferably less than 1 to 6.

6. The composite material according to claim 1, characterized in that at least one further filler (D) is present in addition to the filler (C).

7. The composite material according to claim 6, characterized in that the further filler (D) has a smaller size than the filler (C).

8. The composite material according to claim 7, characterized in that the further filler (D) has a higher Mohs hardness than the filler (C).

9. The composite material according to claim 8, characterized in that the weight ratio of the further filler (D) to the filler (C) is more than 1 to 3, preferably more than 1 to 4, particularly preferably 1 to 5, and the Mohs hardness of the further filler (D) is equal to or higher than the Mohs hardness of the reinforcing fibers (B).

10. The composite material in particular according to claim 1, characterized in that the Mohs hardness of the filler (C) is between 1 and 5, preferably between 2 and 4, particularly preferably 3, on the Mohs hardness scale.

11. The composite material in particular according to claim 1, characterized in that the filler (C) and/or the further filler (D) is/are a pigment filler.

12. The composite material according to claim 11, characterized in that the pigment filler is a white pigment and/or a color pigment.

13. The composite material in particular according to claim 1, characterized in that the pigment is formed by zinc sulfide, zinc oxide and/or barium sulfate.

14. The composite material in particular according to claim 1, characterized in that the average size of the pigments is between 0.1 μm and 0.4 μm.

15. The composite material according to claim 1, characterized in that the thermoplastic (A) is a high temperature plastic with a melting or processing temperature of at least 300° C.

16. The composite material according to claim 1, characterized in that the thermoplastic (A) is an aromatic thermoplastic with aryl groups in the main chain.

17. The composite material according to claim 1, characterized in that the thermoplastic (A) is from the group of polyaryletherketones, preferably a polyetheretherketone (PEEK).

18. The composite material according to claim 1, characterized in that the content of reinforcing fibers (B) in the composite material is more than 20 percent by weight, preferably more than 30 percent by weight, and particularly preferably more than 40 percent by weight.

19. The composite material in particular according to claim 1, characterized in that the reinforcing fibers (B) have an average diameter of 50 nm to 25 μm, preferably 300 nm to 15 μm, particularly preferably 3 μm to 10 μm.

20. The composite material in particular according to claim 1, characterized in that the reinforcing fibers (B) possess a length-to-diameter ratio of at least 10:1, preferably at least 20:1, particularly preferably at least 50:1.

21. The composite material in particular according to claim 1, characterized in that the reinforcing fibers (B) are glass fibers, ceramic fibers and/or carbon fibers or a mixture thereof.

22. The composite material according to claim 21, characterized in that the ceramic fibers consist of zirconium oxide and/or aluminum oxide.

23. The composite material in particular according to claim 1, characterized in that the surface of the reinforcing fibers (B) has substantially no surface damage, in particular no scratch marks.

24. The composite material according to claim 1, characterized in that its bending strength is more than 250 MPa, preferably more than 290 MPa, particularly preferably more than 315 MPa.

25. The composite material in particular according to claim 1, characterized in that it is formed by granules or a semi-finished product.

26. The granules according to claim 25, characterized in that the granules or the semi-finished product are long fiber granules or a long fiber semi-finished product.

27. The granules according to claim 25, characterized in that the granules are intended for thermal processing into dental prostheses.

28. The semi-finished product according to claim 25, characterized in that the semi-finished product is intended for thermal processing into dental prostheses.

29. The semi-finished product according to claim 1, characterized in that the semi-finished product is intended for machining into dental prostheses.

30. A dental prosthesis, produced from a composite material according to claim 1.
